(19) United States
(12) Patent Application Publication
(10) Pub. No.: US 2002/0174038 A1
(43) Pub. Date: Nov. 21, 2002

(54) Warehouse system with optimal management flow

(75) Inventor: Chih-Hung Chien, Tao-Yuan Hsien (TW)

Correspondence Address: MERCHANT & GOULD PC, P.O. BOX 2903, MINNEAPOLIS, MN, 55402-0903, US

(73) Assignee: Mitac International Corp., Hsinchu (TW)

(21) Appl. No.: 10/123,467

(22) Filed: Apr. 16, 2002

(30) Foreign Application Priority Data
May 18, 2001 (TW) 090111914

(51) Int. Cl. G06F 17/60

(52) U.S. Cl. 705/28

(57) ABSTRACT

A local product management warehouse system provides a warehouse system to control inspection, and delivery/picking simultaneously, consolidating a plurality of tickets, and transferring bins in and out virtually in a warehouse. A method of automated data capture is used to integrate information of bins to achieve the objective of optimal management flow. The invention comprises the following steps: the warehouse management system generates a work order and a kit order, decides the picking method according to the work order and the kit order, and performs delivery through a controlling mechanism provided by the warehouse management system.

### BACKGROUND OF THE INVENTION

1. Field of the Invention

The invention relates to a warehouse system, and more particularly to a warehouse system with optimal management flows that can access bins randomly.

2. Related Art

With the economic growth of developing countries, the progress in the concept of the world supply chain, the increase of technology of information and communication, and the loosening of the controls on world finance and conveyance, e-business is fast becoming the trend of the future. How businesses handle world supply chain management (SCM), provide customers with high quality products, efficient services, and reduce costs is the key to determine whether they can be competitive in the international market.

In traditional logistic systems, warehousing plays the roles of storing and committing. However, under the pressures of changing requirements, large amounts of complex data, and market competition, to meet the various requirements and limitations, debouchment of bins in the warehouse system has become quicker and more complex. In each technology regarding logistic centers, the use of the automated storage retrieval system (ASRS) is the best solution. Presently in Taiwan, automated storage retrieval systems are mostly used in material warehouses or delivery warehouses in factories. The basic process of ASRS is very simple. The basic unit of stocking/shipping is the pallet. In shipping processes, no picking mode is needed, so ASRS is mostly used for storage. However, while an automated system is installed in a logistic center, the problem of integrating the storage interface and the picking interface is created. The locator layout in the automated system is the key to solving the above problem, as it affects transporting time and usage frequency. Thus, an effective locator layout rule is developed to provide reference to logistic vendors.

Before introducing in detail the capabilities of the system of the invention, a present warehouse system with its limitations is introduced. By differing technologies, the warehouse system is divided into three generations:

Early times: constant warehouse personnel manage constant materials in constant areas.

Limitations are:

1. the system needs to register debouchment processes manually, which often results in mistakes

2. if the warehouse personnel ask for leave, no one knows where the bins are;

3. while picking, individual personnel must decide if an item is picked mistakenly,

4. while checking, individual personnel must decide if an item is picked mistakenly;

5. the warehouse status is not known until all tickets are input for that day;

6. FIFO cannot be controlled;

7. the system cannot determine which products belong to which manufacturers;

8. only after stopping the procedure can an inventory can be made;

9. there is no reservation capability.

At present: each locator can be controlled, the bins can be set in the coded locators randomly, and the system can generate picking lists.

Limitations: Some problems in the old systems have been solved, but some problems still exist:

1. while picking, individual personnel must still decide if an item is picked mistakenly;

2. while checking, individual personnel must still decide if an item is picked mistakenly;

3. the warehouse status is not known until all tickets are input for that day;

4. only after stopping the procedure can an inventory can be made;

5. the reservation capability has time differences.

Today, the economy is highly international and for e-businesses the logistic ability is more and more important. A modern business center integrating logistics, business, cash, and information will be the mainstream. With the advent of a competitive global market, an efficient warehouse system is increasingly becoming the key to success. The warehouse system center is a hub in circulating industry, and if the decision efficacy is improved, then a competitive position can be maintained.

### SUMMARY OF THE INVENTION

It is therefore a primary objective of the invention to provide a bar code on-line process with radio frequency (RF) equipment or a bar code machine to check inventory on a web site to solve the above mentioned problems. Through the bar code, one can control the inventory conditions of each vendor.

Therefore, in light of the above-mentioned primary object, a mode of warehouse management is introduced. Through the warehouse management system, all of the bar codes are controlled. While each item passes in and out of the warehouse center, the inventory data can be updated immediately through RF. In this way, the capabilities of the invention surpassing those of traditional warehouses are as follows:

1. Inventory can circulate anytime without stopping any operations or ticket processing.

2. Paper is replaced by RF to achieve the objective of non-paper record keeping.

3. Anytime the information on the bar code label is needed, no matter if it is for a locator, a material box, a material case, or a pallet, the necessary information can be obtained by scanning on the spot.

4. The traditional material number management is improved to per box and per package management.

5. The control method of the system is first in first out.

6. While picking, there is no need to move the frozen locators; when the box moves, data can be replaced right away.

7. The incoming and outgoing time, the amount of each box and the responsible personnel can be recorded in the bin card management system through RF.

8. The period of time that each box doesn't move or when it is picked can be recorded in real-time.

The invention comprises the follow steps: the warehouse management system generates a work order and a kit order; according to the work order and the kit order a picking method is decided; delivery is performed through a control mechanism provided by the warehouse management system.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1-a is a hierarchical relationship diagram of the product packaging method of the warehouse management system of the invention.

FIG. 1-b is a hierarchical relationship diagram of the different format tickets of the warehouse management system of the invention.

FIG. 2 is a function diagram of the delivery and picking methods of the invention.

FIG. 3 is a flow chart of the delivery process of the invention.

FIG. 4 is a flow chart of the warehouse management system of the invention in an unusual handing over process.

FIG. 5 is a flow chart of the warehouse management system in consolidating kit and separate delivery.

FIG. 6 is a flow chart of the buying out process of the invention.

### DETAILED DESCRIPTION OF THE INVENTION

The invention provides a warehouse system with optimal management flow. For business process reengineering (BPR) and enterprise resource planning (ERP) promoted by the market nowadays, the objective is transforming workflows of warehouses to improve productivity and reduce the organization's working capital. The invention is embodied in a warehouse system to make reserve management, locator shifting, delivery processing., picking, and material handing over of the warehouse system automatically obtainable through a method of automated data capture. For example, every kind of optical or electric scanner or bar code machine for reading data can process data in real-time to avoid the previous problems of warehouse system management.

A preferred embodiment of the invention is disclosed to illustrate the practicality of the invention. As the warehouse management system integrates materials of different suppliers, the management of a work in process is much easier. Before describing the invention, a process and a product hierarchical packing method is first introduced. Before a manufacturer ships products, an advance shipping notice (ASN) is first sent out. According to the ASN, a bar code (BC) of each box of materials is scanned to verify the amount. The bar code is an identification (ID) of each different material. However, not all manufacturers can meet this request. If a manufacturer is unable to supply an ASN, one is inputted for them; if there is no bar code, a bar code is pasted on the product. After scanning the bar code, the system will sum up the amount of different kinds of materials according to a product order (PO) of each box. The system then compares this sum with the amount on the picking list to verify the quantity

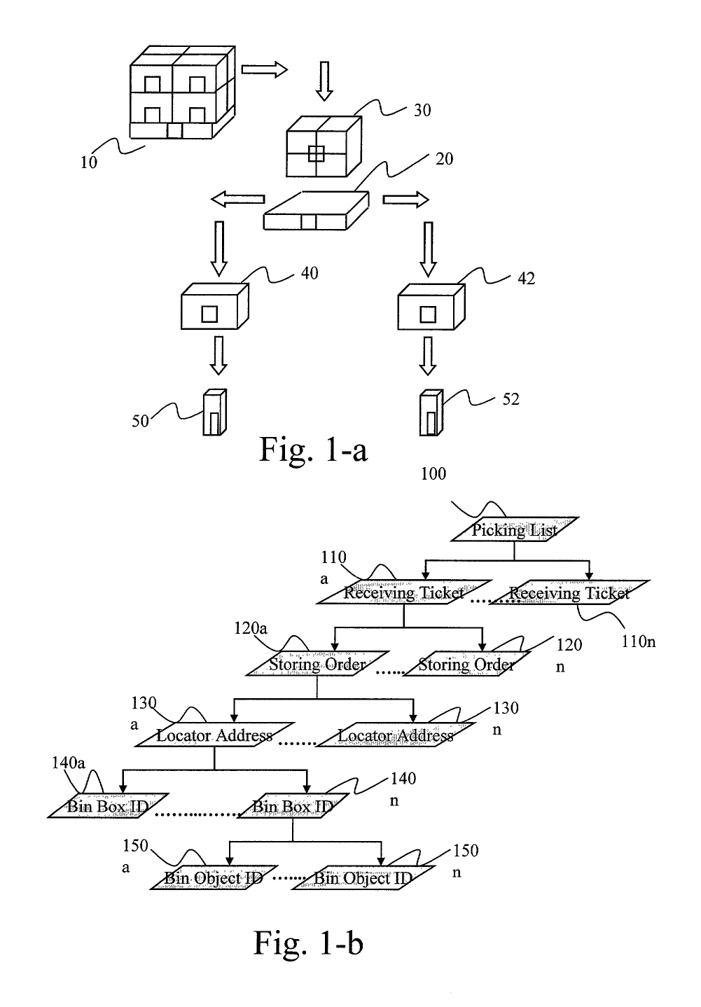

Please refer to FIG. 1-a, which is a hierarchical relationship diagram of the product packaging method of the warehouse management system of the invention. It performs the setting of package units to the locators. For the data layer supplied by the suppliers, the top layer is an ASN or so-called container 10. The container 10 is composed of pallets 20, and a plurality of material boxes 30 are set on each pallet 20. Every material box has the same PO and the same kinds of materials. A material box 30 comprises a plurality of material cases 40, and each material case 40 comprises a plurality of materials 50. A BC label is attached to all units to represent their ID. The warehouse management system provides a bin card. The bin card is used to transform the composed ID to a character description to give a worker the relevant information about the material through the bin card in process.

The above-mentioned data comes from each bar code scanned by radio frequency (RF). After entering the warehouse, the bar code ID becomes the identification number of the box of materials to record which locators the box has passed, the amount of materials received by whom, when they enter, and which manufacturer they belong to for the warehouse management system to manage uniformly.

Please refer to FIG. 1-b, which is a hierarchical relationship diagram of the different format tickets of the warehouse management system of the invention. The hierarchical relationship diagram is described as follows:

After counting the materials and scanning each bar code, the data is transferred via RF to the warehouse management system in real-time. At this time, the warehouse management system generates data of each layer as shown in FIG. 1-b according to data received and generates a plurality of receiving tickets (RT) 110 through a picking list (PL) 100. In the same RT 110, because the package amount is different, we can group the material box 40 of the same material 50 package amount in an RT 110 (the material amount of each material box must be equal) into a storing order (SO) 120. The SO 120 records a plurality of locator addresses 130. Through the locator address, the required material box ID140 and the material ID 150 can be found according to the bar codes.

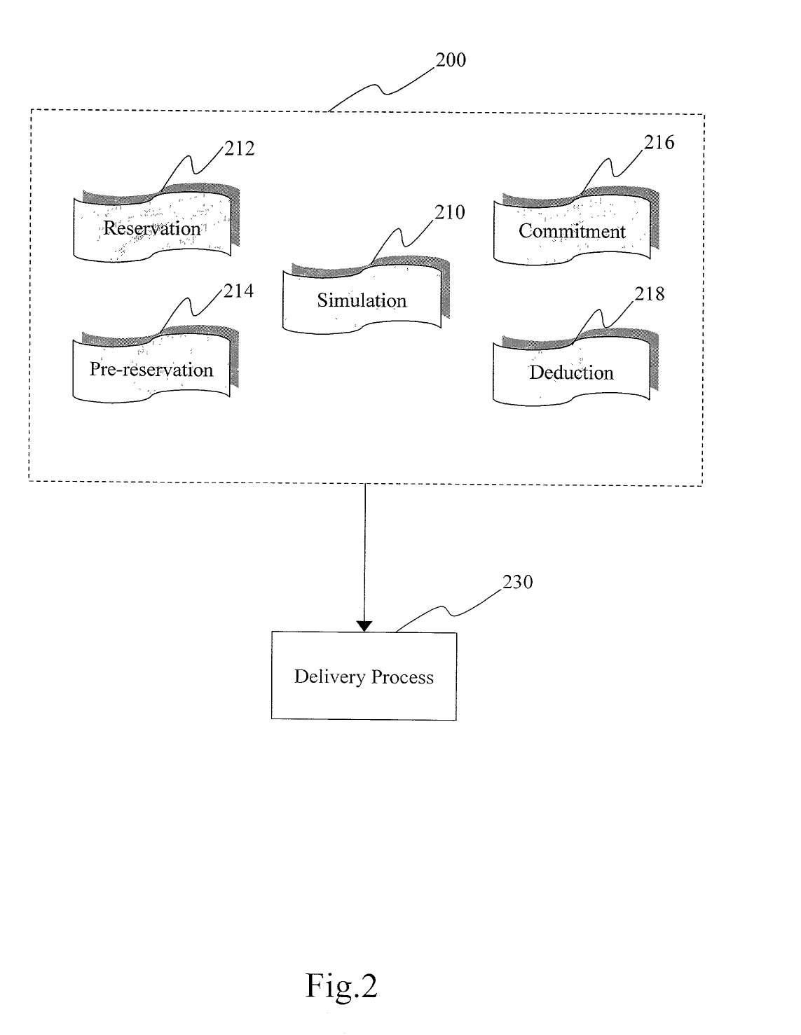

Through the management of the bar codes by the warehouse, the inventory data of each incoming or outgoing warehouse material can be replaced immediately through RF. The delivery process is a complex process. This is because different product types require different picking functions. Please refer to FIG. 2, which is a function diagram of the delivery and picking method of the invention. It shows that the warehouse management system provides a plurality of modules to use a control mechanism to perform delivery and picking processes. The warehouse management system 200 comprises five modules: a simulation module 210, a reservation module 212, a pre-reservation module 214, a commitment module 216, and a deduction module 218. These five modules are set for the delivery process 230. They are used to eliminate the normal mistakes in the delivery process. The five modules are described as follows:

1. The simulation module 210 provides the function of simulation to arrange materials needed during future work in progress through the operations of the warehouse management system 200.

2. The reservation module 212 provides the function of reservation to reserve the materials needed by the simulation module 210 and ensure they will not be used by others.

3 The pre-reservation module 214 provides the function of pre-reservation. The reservation module 212 only reserves the sum of the materials, not each box, which may cause material shortage. At this time, the pre-reservation module 214 determines the status of material shortage and pre-reserves the shortage material. When the shortage material arrives, the warehouse management system 200 can directly reserve the material.

4. The commitment module 216 commits the reserved material to each box to be picked.

5. The deduction module 218 deducts each picked material from the reserved material.

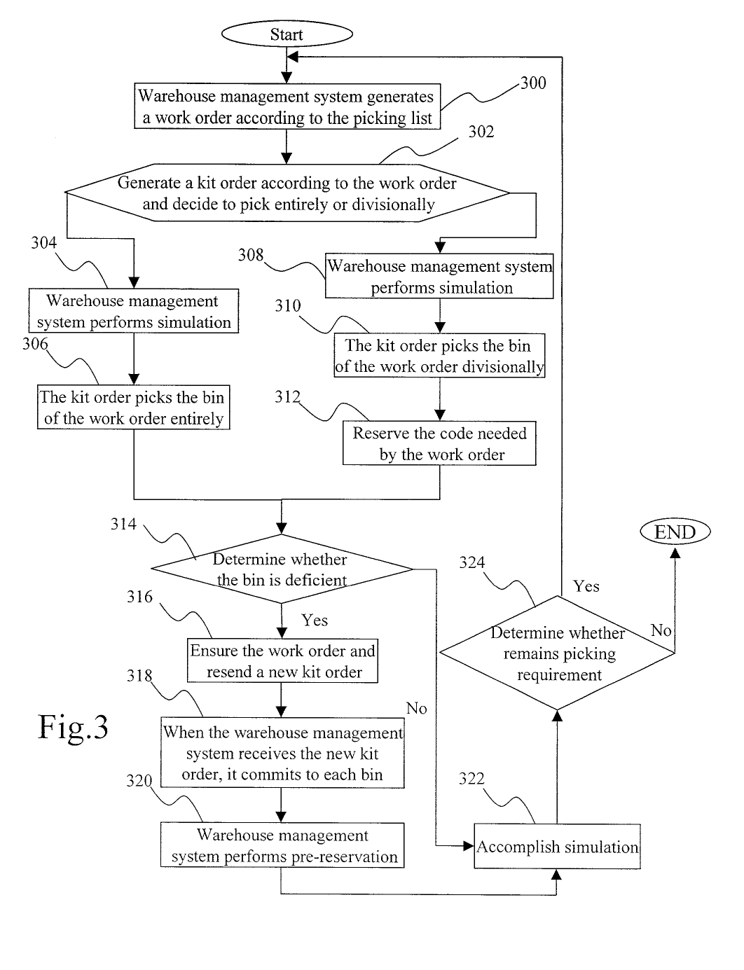

FIG. 3 is a flow chart of the delivery process of the invention. It is described in detail as follows:

First, the warehouse management system 200 generates a work order (WO) according to a picking list 100 (step 300), then generates a kit order (KO) according to the work order and decides to pick entirely or separately (step 302). If picking entirely, the warehouse management system performs a simulation (step 304). The kit order then picks the material of the work order entirely (step 306), and the materials on the work order are taken to the product warehouse. At this time, the KO is equal to the WO. This is suitable for scattered material requests supply requests, or similar configure to order (CTO) requests. If picking separately, the warehouse management system performs a simulation (step 308). The kit order then picks the material of the work order separately (step 310). At this time, the sum of each KO is equal to the WO. If there is a quantity production type, like surface mounting technology (SMT), the production schedule usually lasts 1 to 2 weeks. In this situation, it is unsuitable to pick all the materials at the same time because they may take too much space of the work in progress. It is best to use a small serial picking method. When the materials in the work in progress are less than a safe inventory level, the materials are automatically supplied to the work in progress from the kiting center (KC), and the reserved amount in the original work order is deducted. After that, against the work order, perform reservation to the needed material number (step 312). When all the materials are picked at one time, the system doesn't need to perform the step of reservation for the work order. The system determines whether the material is in shortage (step 314). If it is, the system ensures the status of the work order and resends a new kit order (step 316). When the warehouse management system receives the new kit order, it commits each box of materials (step 318). Because there is a shortage of materials, the warehouse management system performs pre-reservation (step 320). In this way, the simulation is completed (step 322). After that, the warehouse management system automatically determines whether or not picking is still requested. If yes, the system again performs the above-mentioned steps; if it is not, the delivery process is completed.

When performing picking separately, the materials of the PW in work in progress are few and are easy to manage. When changing the work in progress, the remaining materials are sent back to the warehouse management system. From the inventory, boxes of materials can be supplied to the KC. The supplying process in the inventory is very simple and suitable for the ASRS system.

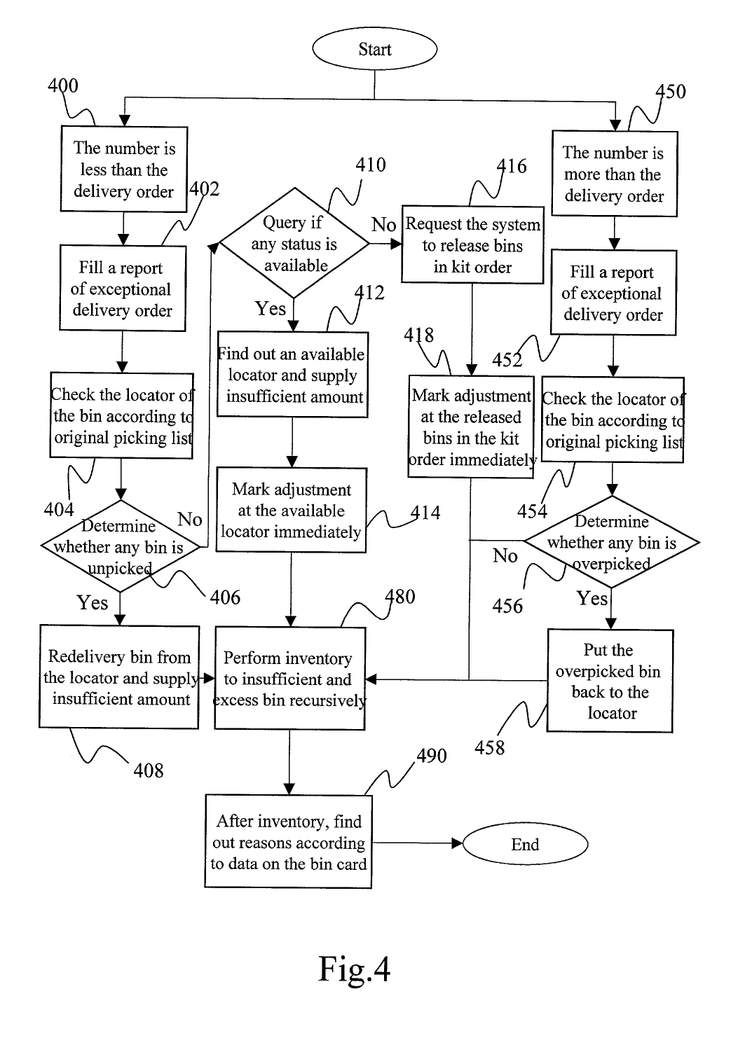

When the warehouse center prepares the required materials, the warehouse management system prints a delivery order (DO) to be a basis in handing over materials. A KO corresponds to a DO. The customers sign the DO to take charge of the materials. The warehouse management system of the invention manages the amount of each box of materials, and the loss or fill status of each box of materials is determined immediately. The above-mentioned situations usually occur in picking or handing over. The process flow is shown in FIG. 4, which is a flow chart of the warehouse management system of the invention in an unusual handing over process. It is described in detail as follows:

The unusual handing over process can be divided into two kinds: shortage or excess. First, when the warehouse management system finds that the handing over amount is less than the DO (step 400), a worker submits a report of the mistaken delivery order (step 402). The content of this report can be of different formats according to different material categories. It comprises the handler's name, the handing time, the number and amount of the shortage/excess materials. The objective is to record the shortage amount, the time and the worker's name. According to the picking list, check the locator of the material (step 404). The original picking list can be known from the delivery list to find out the locator of the material and determine whether any material was not picked (step 406). If material was not picked, redeliver the material from the locator and supply the sufficient amount (step 408). This picking does not need to be recorded in the warehouse management system. Finally, check inventory of the insufficient and excess materials (step 480). After the inventory is checked, according to the data of the bin card on each box, find out the reason (step 490). If no, query the warehouse management system if any status is available (step 410). If yes, find out an available locator and supply the insufficient amount (step 412). After that, immediately make an adjustment mark at the available locator (step 414). The adjustment mark prevents the materials from being committed by other kit orders. Then go to step 480. If there is no usable material, request the system to release the materials in a kit order according to the report of the mistaken delivery order (step 416). Next, immediately make an adjustment mark on the released materials in the kit order (step 418). Then perform step 480. Finally, after inventory, find out the reasons for the mistaken delivery according to the data of the bin cards on each box (step 490) to be a basis for improvement next time.

When the warehouse management system determines that the amount of materials handed over is more than the delivery order (step 450), a worker submits a report of the mistaken delivery order (step 452). After that, check the locator of the material according to the original picking list (step 454), which can be obtained from the delivery order to determine whether any material is overpicked (step 456). If it is, return the overpicked material to the locator (step 458), and then go to the step 480. After inventory, find out the reasons for the mistaken delivery according to the data of the bin cards on each box (step 490). If material is not overpicked, go directly to step 480 and complete step 490.

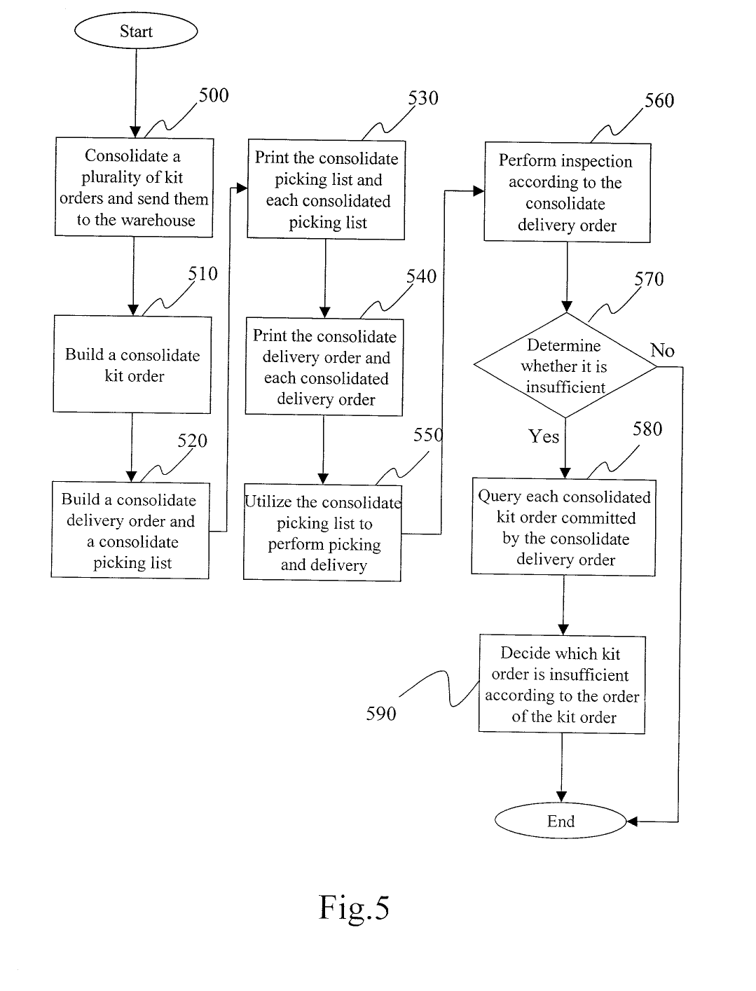

The warehouse management system provides the function of consolidating a plurality of KOs to pick and deliver together. Please refer to FIG. 5, which is a flow chart of the warehouse management system in consolidating kit orders and separate delivery. It is described in detail as follows:

First, consolidate a plurality of kit orders and send them to the warehouse (step 500). Build a consolidated kit order for the plurality of KOs in the warehouse management system (step 510). Also build a consolidated delivery order (CDO) and a consolidated picking list (CPL) according to the consolidated kit order (CKO) (step 520). Print each consolidated picking list (step 530), the consolidated delivery order and each consolidated delivery order (step 540). After that, a worker utilizes the consolidated picking list to perform picking and delivery (step 550). Next, perform the handing over process according to the consolidated delivery order (step 560) and determine whether the material amount is insufficient (step 570). If it is, then query each consolidated kit order committed by the consolidated delivery order (step 580) and decide which kit order is insufficient according to the order of the kit orders (step 590). If the material amount is sufficient, then directly end the process.

After consolidating picking, the warehouse also provides the function of sorting picking again for consolidated picking materials according to the PL of each KO under the CPL. Sorting picking can be used in the picking system whose CTO or BTO is small and the amount is sufficient.

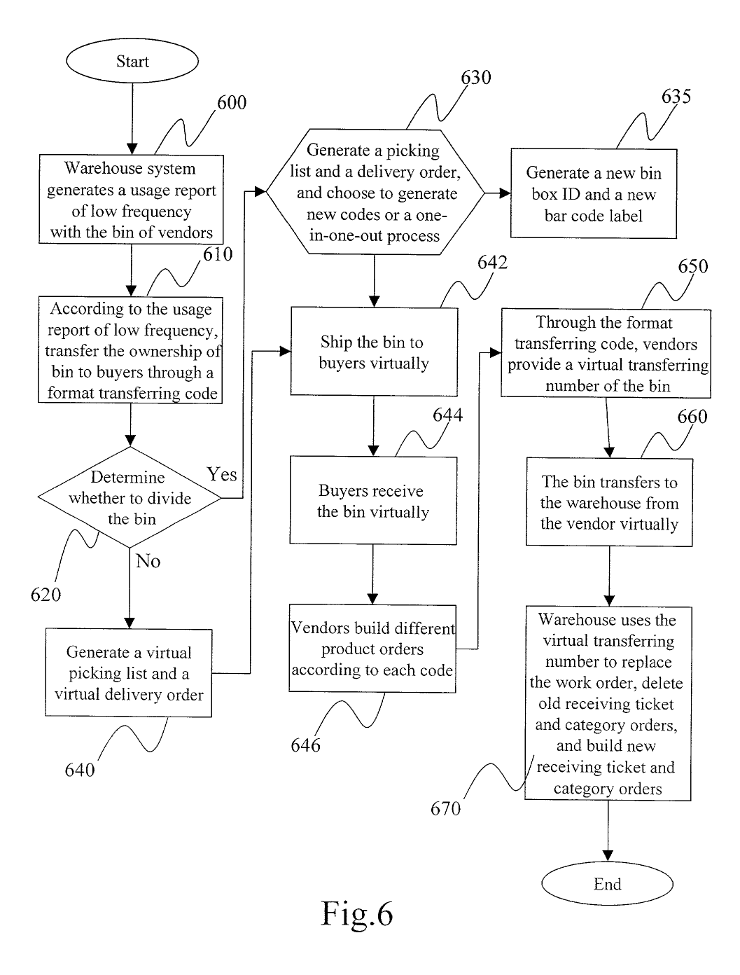

If the materials of the suppliers in the warehouse management system are unused for a long time, the suppliers may request that the customers buy them. At this time, the warehouse management system generates new one-in-one-out data. The locators are not changed, but the bar codes on each box or each case are replaced. Therefore, there are virtual incoming and outgoing data processes. At this time, the suppliers receive a message of confirming products shipped to the customers. The customers receive a message confirming receipt of new materials. The warehouse management system has generated two messages, one incoming and one outgoing. This process is called the buy out process. If the materials should be held by the same customer, but their sub inventory codes (SIC) are different, the movement should go under the buy out process to ensure the accuracy of each box of data. FIG. 6 is a flow chart of the buying out process of the invention. It is described in detail as follows:

First, the warehouse system generates a low frequency usage report for the materials of the vendors (step 600) and transfers the ownership of the materials to the buyers through a format transferring code according to the low frequency usage report (step 610). The buyers determine whether to divide the materials (step 620). If the materials are to be divided, generate a picking list and a delivery order, and choose to generate new bar codes or a one-in-one-out process (step 630). If the new bar codes are selected to be generated, then generate a new material box ID and a new bar code label (step 635). If the one-in-one-out process is selected to be generated, then ship the materials to the buyers virtually through the picking list and the delivery order (step 642). Next, the buyers receive the materials virtually (step 644). After the buyers check them, the vendors build different product orders according to each material number (step 646). Furthermore, through the format transferring code, the vendors provide a virtual transferring number for the materials (step 650). The materials are transferred to the warehouse from the vendor virtually (step 660). The warehouse uses the virtual transferring number to replace the work order, deletes the old receiving ticket and category orders, and builds a new receiving ticket and category orders (step 670). If the materials are not to be divided, generate a virtual picking list and a virtual delivery order (step 640), and then go to step 642. After that, follow the process after step 642. The above mentioned virtual picking list and virtual delivery order is different from the normal picking list and delivery order. This is because the virtual picking list and virtual delivery order are only delivery messages. The operations of virtually receiving and delivering materials are managed by the warehouse management system to achieve the objective of optimization. The format transferring code provided by the warehouse management system generates a virtual transferring number for different materials of low usage frequency. The buyers and the vendors only need the number to find the virtually incoming and outgoing materials.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A warehouse system with an optimal management flow getting information of bins through automated data capture equipment and providing a warehouse management system to perform a delivery process; the delivery process comprising
the warehouse management system generating a work order and a kit order;
deciding picking method according to the work order and the kit order; and
performing delivery through a controlling mechanism provided by the warehouse management system.

2. The warehouse system with an optimal management flow of claim 1 wherein the step of work order and the kit order deciding the picking method comprises picking entirely or picking divisionally.

3. The warehouse system with an optimal management flow of claim 2 wherein the picking entirely is picking bins in the work order at a clip, and the bins needed by the work order equal the bins picked by a kit order.

4. The warehouse system with an optimal management flow of claim 3 wherein the step of picking bins in the work order at a clip further comprises:
performing simulation according to the work order and the kit order;
determining a status of shortage of the bins through the warehouse management system;
committing the shortage bins to each bin box and performing pre-reservation; and finishing simulation.

5. The warehouse system with an optimal management flow of claim 2 wherein the picking divisionally is picking bins in the work order respectively, and the bins needed by the work order are amount of the bins picked by a plurality of kit orders.

6. The warehouse system with an optimal management flow of claim 5 wherein the step of picking bins in the work order respectively further comprises:
performing simulation according to the work order and the kit order;
reserving the bins of the needed codes;
determining a status of shortage of the bins through the warehouse management system;
committing the shortage bins to each bin box and performing pre-reservation; and finishing simulation.

7. The warehouse system with an optimal management flow of claim 1 wherein the control module comprises:
a simulation used to simulate against the delivery and picking, count the predetermined amount of the production line, and generate a schedule signal;
a reservation used to provide an ability of reserving bins, reserve the bins of the schedule signal, and generate a reservation signal;
a pre-reservation used to determine the status of shortage of the bins, perform pre-reservation, and generate a pre-reservation signal;
a commitment used to ensure the reserved and pre-reserved bins, commit to deliver the bins, and generate a commitment signal according to the reservation signal and the pre-reservation signal; and
a deduction used to provide an ability of deducting the amount of bins and perform deducting through the commitment signal when picking.
The above warehouse management system performs controlling through the five flows.

8. A warehouse system with an optimal management flow providing inspection and generating a delivery order and a kit order through the warehouse management system to compare; when the amount of inspection and the amount of the delivery order are different, the warehouse management system performs an exceptional inspection process, and the exceptional inspection process comprises:
filling a report of exceptional delivery order;
checking a locator of the bin and modifying a debouchment record of the delivery order
performing inventory to the bin recursively;
performing checking according to data on bin cards of each box; and
wherein the above inspection is used to inspect against the delivery and the picking process, control each box of bins through the warehouse management system, and find out the excess and insufficient bins.

9. The warehouse system with an optimal management flow of claim 8 wherein the report of exceptional delivery order comprises inspector's name, inspecting time, code and amount of the insufficient/excess bins.

10. The warehouse system with an optimal management flow of claim 8 wherein the step of modifying a debouchment record of the delivery order further comprises a step of determining any bin is unpicked/overpicked.

11. The warehouse system with an optimal management flow of claim 10 wherein the step of determining any bin is unpicked further comprises when ensuring there are unpicked bins, redelivery bin from the locator to supply insufficient amount, and when ensuring there aren't unpicked bins, query if any status is available.

12. The warehouse system with an optimal management flow of claim 11 wherein if there is status available, it further comprises:
finding out an available locator and supplying insufficient amount; and
marking adjustment at the available locator immediately.

13. The warehouse system with an optimal management flow of claim 11 wherein if there is no status available, it further comprises:
requesting the system to release bins in a kit order; and
marking adjustment at the released bins in the kit order immediately.

14. The warehouse system with an optimal management flow of claim 10 wherein the step of determining any bin is overpicked further comprises a step of putting the overpicked bin back to the locator directly.

15. A warehouse system with an optimal management flow providing a method of consolidating kits and separating delivery; the method comprising:
consolidating a plurality of kit orders, sending them to a warehouse, and building a consolidate kit order;
building a consolidate delivery order and a consolidate picking list according to the consolidate kit order;
performing picking and delivering according to the consolidate picking list;
performing inspection according to the consolidate delivery order;
performing inspection determination;
querying each consolidated kit order committed by the consolidate delivery order; and deciding which kit order is insufficient according to the order of the kit order.

16. A warehouse system with an optimal management flow providing a method of buying flow; the method comprises:
the warehouse system generating a usage report of low frequency with the bins of vendor;
according to the usage report of low frequency, transferring the ownership of bins to a buyer through a format transferring code;
shipping the bins to the buyer virtually;
the buyer receiving the bins virtually;
the vendor building different product orders according to each code of the bins;
through the format transferring code, the vendor providing a virtual transferring number of the bins;
the bins transferring to a warehouse from the vendor virtually; and
the warehouse system using the virtual transferring number to build new receiving ticket and category orders.

17. The warehouse system with an optimal management flow of claim 16 wherein the step of transferring the ownership of bins to a buyer through a format transferring code further comprises steps of whether to divide the bins:
when dividing the bins, generating a virtual picking list and a virtual delivery order, and choosing to generate new codes or a one-in-one-out process; and
when not dividing the bins, generating a virtual picking list and a virtual delivery order.

18. The warehouse system with an optimal management flow of claim 17 wherein the step of dividing the bins further comprises generating a new bin box ID and a new bar code label.

19. The warehouse system with an optimal management flow of claim 16 wherein the virtual transferring number is used to replace the work order and delete old receiving ticket and category orders.
